(19) United States
(12) Patent Application Publication
(10) Pub. No.: US 2014/0356503 A1
(43) Pub. Date: Dec. 4, 2014

(54) Method And Apparatus For Scaling Dough

(71) Applicant: John H. Moynihan, Florence, MA (US)

(72) Inventor: John H. Moynihan, Florence, MA (US)

(21) Appl. No.: 14/290,122

(22) Filed: May 29, 2014

Related U.S. Application Data
(60) Provisional application No. 61/828,460, filed on May 29, 2013.

(51) Int. Cl. A21C 3/04; A21D 8/02

(52) U.S. Cl. CPC A21C 3/04; A21D 8/02
USPC 426/502; 425/238; 425/162

(57) ABSTRACT

An apparatus for scaling dough and method of using the same includes a pair of infeed rollers that provide dough to pair of positive pressure rollers that rotate faster that the rate dough is received. A bed defines a ram chamber with an inlet and an outlet. The bed is adjacent to the pair of positive pressure rollers. Dough is received in the ram chamber through the inlet. A ram disposed in the ram chamber reciprocates therein to compress dough. A rotatable head with a scaling chamber is adjacent the outlet of the ram chamber. The rotation of the head and the reciprocation of the ram are synchronized so that a downward stroke of the ram compress dough received in the ram chamber into the scaling chamber.

### FIELD OF THE INVENTION

The present invention relates to a method and apparatus for scaling dough. In particular, the present invention relates to a method and apparatus for accurately dividing and scaling dough for bagels and other bread products.

### BACKGROUND OF THE INVENTION

It is known to use scaling machines to divide and form dough for the production of bagels and other bread products. Such machines typically have a rotatable head having a plurality of scaling chambers disposed on a surface thereof. Such rotatable heads typically have a circular cross section. The scaling chambers are typically arranged in longitudinal rows extending along an axis in the circumference of the head parallel to an axis of rotation of the head. Blocks of dough are fed into the machine and formed into a ribbon by one or more rollers. A reciprocating ram subsequently extrudes the dough into the scaling chambers of the head as it rotates, thereby forming portions of scaled dough in each of the scaling chambers. As the head rotates further, scaling pistons being slidably disposed in the scaling chambers eject the scaled dough from the scaling chambers. The ejected dough is received on one or more surfaces that convey the scaled dough away further processing.

A disadvantage of known apparatuses for scaling dough is that reciprocation of the ram is typically limited forty-five to fifty strokes per minute, thereby limiting the output of the apparatus.

Another disadvantage with such known apparatuses and methods is that there is a relatively wide error range in the actual weight of the scaled pieces of dough relative to the desired weight. For example, in some apparatuses this error can range between eight percent, plus or minus, of a specified weight. This error rate can cause significant problems in subsequent steps in the baking process and can also lead to significant loss of product, and thereby revenue.

Another disadvantage of known apparatuses and methods for scaling dough is that wide error range in weight of the scaled dough increases as the strokes per minute of the ram increases.

Another disadvantage of known apparatuses and methods for dividing dough is that the dough tends to accumulate on the surface of the rotating head, and especially the portions thereof proximate to the scaling chambers. As a result, the apparatus must be routinely stopped and cleaned, leading to periods of down time. This disadvantage may be further magnified by the fact that it is difficult and time consuming to remove portions of the head defining the scaling chamber.

What is needed then is an improved method and apparatus for scaling dough which minimizes the above-described disadvantages of known scaling machines.

### SUMMARY OF THE INVENTION

It is an object of the present invention to provide method and apparatus for scaling dough which avoids the problems associated with the known systems and methods.

These and other objects of the present invention are achieved by provision of an apparatus for volumetric scaling of dough. The apparatus comprises a pair of infeed rollers configured to receive a block of dough and form a ribbon therefrom. A pair of positive pressure rollers is adjacent to the infeed rollers and is configured to receive the ribbon of dough from the infeed rollers. The positive pressure rollers are further configured to rotate so that a speed of an outer surface the pair of positive pressure rollers is greater than a speed of the ribbon of dough being received by the positive pressure rollers from the infeed rollers. The apparatus further includes a bed defining a ram chamber having an inlet and an outlet. The bed is adjacent to the pair of positive pressure rollers so that dough passed through the positive pressure rollers is received in the ram chamber through the inlet. The rotation of the positive pressure rollers maintains a sufficient supply of dough in the ram chamber to enable continuous operation of the apparatus. A ram is disposed in the ram chamber and is configured to reciprocate therein so as to compress at least a portion of the dough received therein. A rotatable head having at least one adjustable scaling chamber is adjacent the outlet of the ram chamber. The rotation of the head and the reciprocation of the ram are synchronized such that a downward stroke of the ram compresses dough received in the ram chamber, thereby forcing a portion of the dough in the ram chamber through the outlet of the ram chamber and into the scaling chamber. The rotation of the head relative to the bed shears the dough received in the scaling chamber against an edge of the ram chamber causing it to separate from the dough disposed in the ram chamber, thereby forming a scaled portion of dough.

In a further embodiment of the present invention, the speed of the outer surface of the pair of positive pressure rollers is between two and three times greater than the rate of the ribbon of dough being received by the positive pressure rollers from the pair of infeed rollers. It should be understood that the rate of rotation of the positive pressure rollers can be adjusted to achieve a desired operation for a specific product.

In yet a further embodiment of the present invention, the head further includes a cassette extending along a length of a circumference of the head parallel to an axis of rotation of the head, the scaling chamber being disposed in the cassette. In yet a further embodiment, the cassette includes a plurality of adjustable scaling chambers.

In yet a further embodiment of the present invention, the head has three cassettes and each cassette extends along a length of the circumference of the head parallel to the axis of rotation of the head. Each of the cassettes is positioned at 120 degree intervals along the circumference of the head about the axis of rotation.

In yet further embodiments of the present invention, the ram makes eighty or more strokes per minute. In yet a further embodiment of the present invention, the ram makes one hundred or more strokes per minute.

In yet a further embodiment of the present invention, the pair of infeed rollers comprises a first pair of infeed rollers and a second pair of infeed rollers. The first and second pairs of infeed rollers are positioned so that the first pair of infeed rollers receives the block of dough and forms a ribbon of dough therefrom. The second pair of infeed rollers is adjacent to the first pair of infeed rollers so that the second pair of infeed rollers receives and further forms the ribbon of dough.

In yet a further embodiment of the present invention, one or more of the first pair of infeed rollers and the second pair of infeed rollers comprises a chevron relief pattern on a surface thereof to facilitate formation of the ribbon of dough and bias the ribbon of dough toward a center point of the infeed rollers.

In yet a further embodiment of the present invention, each of the first pair of infeed rollers, the second pair of infeed rollers, and the positive pressure rollers are independently driven. In yet a further embodiment of the present invention, the rate of rotation of each of the first pair of infeed rollers, the second pair of infeed rollers, and the positive pressure rollers can be independently varied.

In yet a further embodiment of the present invention, a controller is provided. The controller is in communication with a drive system associated with each pair of rollers. The apparatus further includes one or more devices for monitoring the rate of dough exiting a pair of rollers. Software executing on the controller adjusts the rate of rotation of one or more of the pairs of rollers based on information received from the one or more monitoring devices. In yet a further embodiment of the present invention, the one or more monitoring devices comprises an infrared eye.

In yet a further embodiment of the present invention, a scaling piston is disposed in each scaling chamber. The position of the scaling piston in the scaling chamber is controlled by a cam in mechanical communication with the head.

In yet a further embodiment of the present invention, the cam and the head are configured to open the scaling chamber to a maximum extent when the scaling chamber is adjacent to the outlet of the ram chamber, and further configured to close the scaling chamber to a minimum extent when the scaling chamber has rotated past the outlet of the ram chamber, thereby ejecting the scaled portion of dough. In yet a further embodiment of the present invention, a scaling bar disposed in the scaling chamber below the scaling piston determines a weight, a least in part, of the scaled portion of dough.

In yet a further embodiment of the present invention, each cassette is received in the head and fixed relative thereto via two mechanical locks being operable by a locking key. In yet a further embodiment of the present invention, the head is configured so that an operator can remove a cassette from the head using two locking keys.

The invention and its particular features and advantages will become more apparent from the following detailed description considered with reference to the accompanying drawings.

### BRIEF DESCRIPTION OF THE DRAWINGS

FIG. 1 illustrates an apparatus for scaling dough in accordance with one embodiment of the present invention.

FIG. 2 is a cross section view of a portion of the apparatus illustrated in FIG. 1.

FIG. 3 is a cross section view of a portion of the apparatus illustrated in FIG. 1.

FIG. 4 is a top view of a portion of the apparatus for scaling dough shown in FIG. 1

FIG. 5A is a cross section view of a head and a cassette in accordance with one embodiment of the present invention.

FIG. 5B is a cross section view of a bed and a ram in accordance with one embodiment of the present invention.

FIG. 6A illustrates a bed in accordance with one embodiment of the present invention.

FIG. 6B illustrates a bed in accordance with one embodiment of the present invention, in which a portion of a cassette of the head is visible through the outlet of the ram chamber defined by the bed.

FIG. 7A is a view of the positive pressure rollers positioned adjacent to the inlet of the ram chamber defined by the bed in accordance with one embodiment of the present invention.

FIG. 7B is another view of the positive pressure rollers shown in FIG. 7A.

FIGS. 8A-8K illustrate operation of an apparatus for scaling dough in accordance with one embodiment of the present invention.

FIGS. 9A-9C show images of a cassette being removed from the head via the key system in accordance with one embodiment of the present invention.

FIGS. 10A-10L illustrate operation of an apparatus for scaling dough in accordance with one embodiment of the present invention.

### DETAILED DESCRIPTION OF THE INVENTION

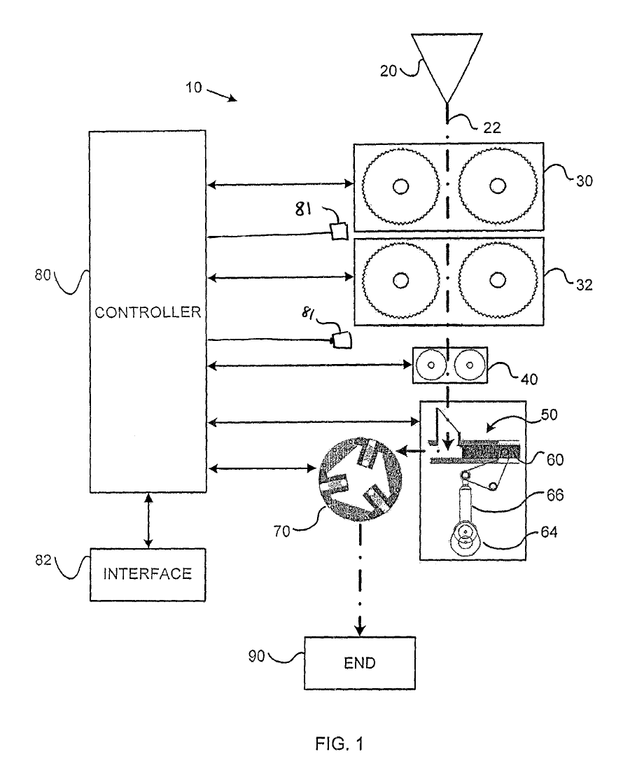

In reference to FIG. 1, an apparatus 10 in accordance with one embodiment of the present invention is shown. Dough for baking, for example for baking bagels, may be fed into the apparatus 10 via an infeed conveyor (not shown in FIG. 1). Dough may be provided by the conveyer in blocks. The blocks, may be, for example, approximately 6″×6″×24″. The conveyor deposits the blocks into a hopper 20. In reference to FIG. 1, the path of the dough through the apparatus 10 is illustrated, in part, by a dashed line 22. The hopper 20 is formed by two cheeks and a gate, such that when the supply of the baking dough falls below a predetermined point, the conveyor is activated to deliver more baking dough to the hopper 20 to ensure a positive supply of dough to the infeed rollers 30, 32.

The apparatus 10 includes a first pair of infeed rollers 30 adjacent to the hopper 20 and a second pair of infeed rollers 32 adjacent to the first pair of infeed rollers. The first and second pair of infeed rollers 30, 32 operate to receive the blocks of dough from the hopper 20 and form a ribbon therefrom that is acceptable for scaling by the bed 50 and the head 70 (described in further detail below). In the embodiment shown in FIG. 1, the formed ribbon is approximately 1¼″ thick. It should be understood, however, that the present invention is not limited in this regard and that the thickness of the ribbon may vary. Similarly, the distance between the rollers, in both the first pair of infeed roller 30 and the second pair of infeed rollers 32, described in further detail below, is adjustable to achieve ribbons having different thicknesses.

The first pair of infeed rollers 30 comprises a first roller and a second roller. The first roller and the second roller are spaced apart and fixed relative to each other to form a first nip. The first pair of infeed rollers 30 is operated by a first motor. The first pair of infeed rollers 30 is adjacent to the hopper 20 such that blocks of dough received in the hopper rest against a top surface of the first pair of infeed rollers 30. As the first pair of infeed rollers 30 rotates, the first pair of infeed rollers pull dough through the first nip, thereby forming a ribbon of dough. The first pair of infeed rollers of rollers 30 is rotated via the first motor such that a speed of an outer surface of each roller is approximately the same speed as the ribbon of dough passing therethrough.

The second pair of infeed rollers 32 is similar to the first pair of infeed rollers 30. The rollers in the pair 32 are spaced apart and fixed relative to each other to form a second nip. The second pair of infeed rollers 32 is operated by a second motor. The second pair of infeed rollers 32 is adjacent to the first pair of infeed rollers 30 such that dough passed through the first nip is received through the second nip defined by the second pair of infeed rollers. As the second pair of infeed rollers 32 rotate, they pull dough through the second nip, thereby further forming the ribbon of dough. The second pair of infeed rollers 32 is rotated via the second motor such that a speed of an outer surface of each roller is approximately the same speed as the ribbon of dough passing therethrough. In the embodiment shown, the second motor is independent from the first motor, although the present invention is not limited in this regard. For example, the first pair of rollers 30 and the second pair of roller 32 may be driven by the same motor.

In reference to FIG. 4, a top view of the apparatus 10 in accordance with one embodiment of the present invention is shown. The first pair of infeed rollers 30 is formed from polyoxymethylene (Delrin®) and define a chevron relief pattern on an outer surface 31 thereof to facilitate formation of the ribbon of dough through the first nip. The chevron pattern is configured on the surface 31 of each roller such that a point of the chevron is located in an approximate center of the infeed roller as measured along a length of the infeed roller parallel to the axis of rotation thereof. The point of the chevron pattern is further configured such that it faces the direction of rotation of the first pair of infeed rollers 30. This configuration is illustrated in FIG. 4. The chevron relief pattern facilitates flow of the dough through the first nip by encouraging a uniform flow that that is centered along the length of the first pair of infeed rollers 30. The second pair of infeed of rollers 32 also is formed from polyoxymethylene (Delrin®) and each of the rollers of the pair also have a chevron relief pattern. It should be understood by a person of ordinary skill in the art that the one more of the first infeed rollers 30 and the second infeed rollers 32 may not include chevron relief pattern. The ends of the first pair of infeed rollers 30 and the second pair of infeed rollers 32 may be closed by side cheeks so as to further facilitate positioning of the ribbon of dough relative to the infeed rollers 30, 32.

Each of the first pair of rollers 30 and the second pair of roller 32 is independently driven by the first motor and the second motor, respectively. Each motor has an associated variable frequency drive to control the speed of the associated pair of infeed rollers 30, 32. In some embodiments of the present invention, the speed at which the ribbon of dough is passed through each nip is monitored by a device, such as an infrared eye 81. Information indicative of a flow rate of dough through a respective nip is transmitted to a processor based controller 80 having software executing thereon. The controller 80 is further in communication with the first and second motors. An operator can enter a preferred dough flow rate into the controller 80 via an interface 82. Software executing on the controller 80 adjusts the speed of the first set of infeed rollers 30 and the second set of infeed rollers 32 based on information received by the monitoring devices 81 and on the preferred dough flow rate. In this manner, the controller 80 can help ensure that the proper amount of dough is received by the bed 50 and head 70 (described below) while at the same time not overloading the apparatus 10 with dough such that it requires additional cleaning or maintenance. For example, if a particular pair of infeed rollers is feeding dough faster than it is being consumed, the dough could begin to bulge out. When the bulge is large enough, it interrupts the infrared eye 81, indicating that the flow rate of dough is too high. When the infrared eye 81 is interrupted, a signal is transmitted to the controller 80. Software executing on the controller 80 generates a signal indicative of a slower speed for the associated motor and transmits the signal thereto thereby correcting the problem.

After the dough is formed into a ribbon by the infeed rollers 30, 32 it is fed into a pair of positive pressure rollers 40. The pair of positive pressure rollers 40 are configured to force the ribbon of dough through an inlet 52 of a bed 50 into a ram chamber 53 defined by the bed 50. The pair of positive pressure rollers 40 is adjacent to the second pair of infeed rollers 32. The pair of positive pressure rollers 40 is further adjacent to an inlet 52 of the ram chamber 53 defined by the bed 50 such that dough that passes through the pair of positive pressure rollers 40 and is forced into the ram chamber 53. As is shown in FIGS. 7A-7B, the pair of positive pressure rollers 40 define an enclosure that is in communication with the inlet 52 of the ram chamber 53 to facilitate the compression of dough into the ram chamber 53.

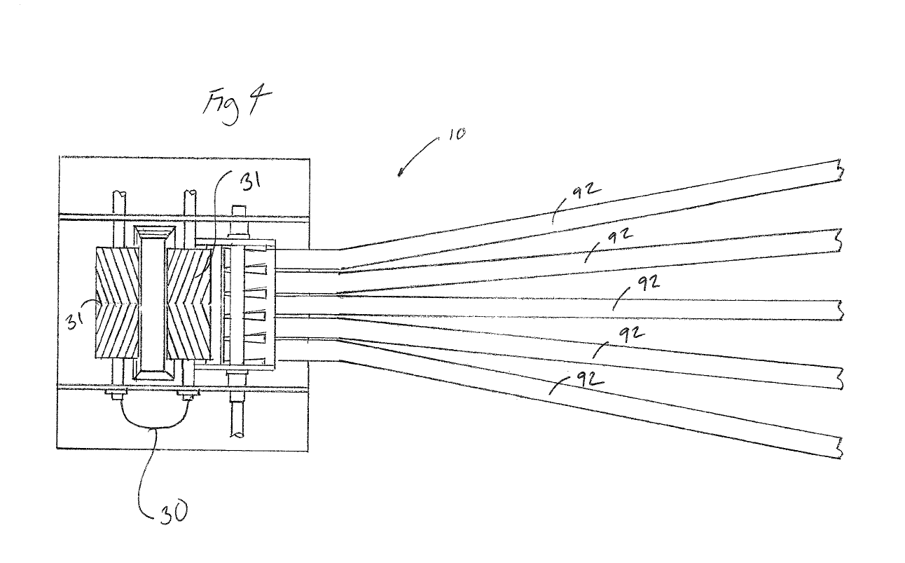

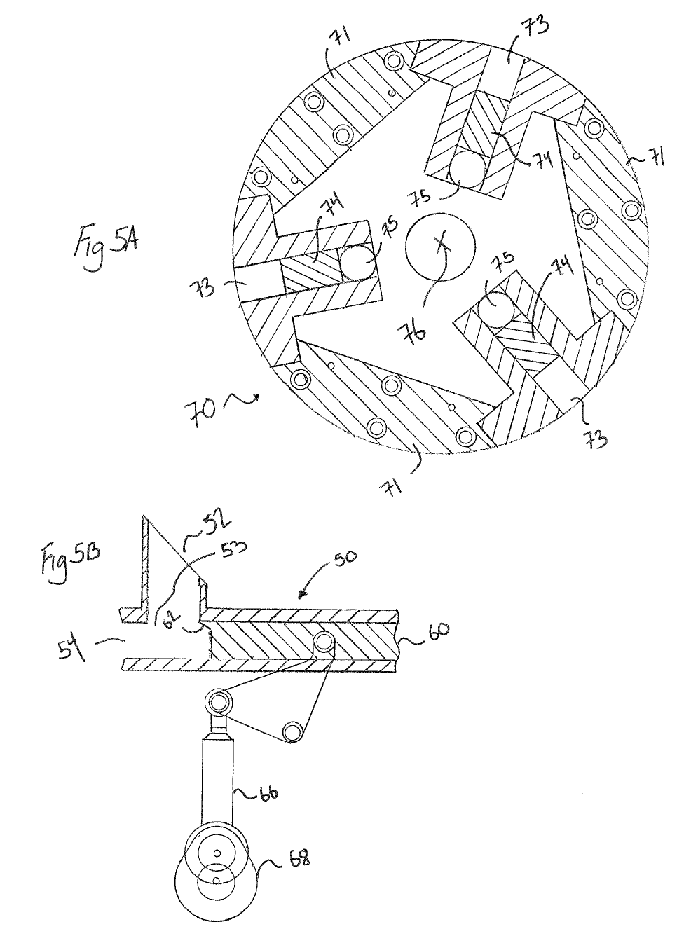

In reference to FIG. 5B, the bed 50 and ram 60 are illustrated. The bed 50 defines a ram chamber 53 having an inlet 52 and out outlet 54. A ram 60 is slidably disposed in the ram chamber 53. The ram 60 is connected to a motor 68 via a linkage assembly. The motor 68, via the linkage assembly, is configured to reciprocate the ram 60 in the ram chamber 53. As is shown in FIG. 1, and as discussed in further detail blow, the outlet 54 of the ram chamber 53 is adjacent to and outer surface of the head 70. The head 70 rotates relative to bed 50. As is shown in FIG. 5B, the outlet 54 has a radius of curvature that conforms to that of the head 70. The head 70 includes at least one adjustable volumetric scaling chamber 73 in a surface thereof. The volume of scaling chamber 73 is adjustable to provide volumetric scaling of dough of different amounts as desired by setting the maximum volume of the scaling chamber 73. As the scaling chamber 73 rotates past the outlet 54 of the ram chamber 53, the ram 60 makes a down stroke, thereby forcing a portion of the dough accumulated in the ram chamber 53 through the outlet 54 and into the passing scaling chamber 73. As the head 70 rotates past the outlet 54 of the ram chamber 53, the edge of the outlet 54 shears the dough disposed in the scaling chamber 73 from the dough accumulated in the ram chamber 73, thereby depositing a scaled portion of dough in the scaling chamber 73.

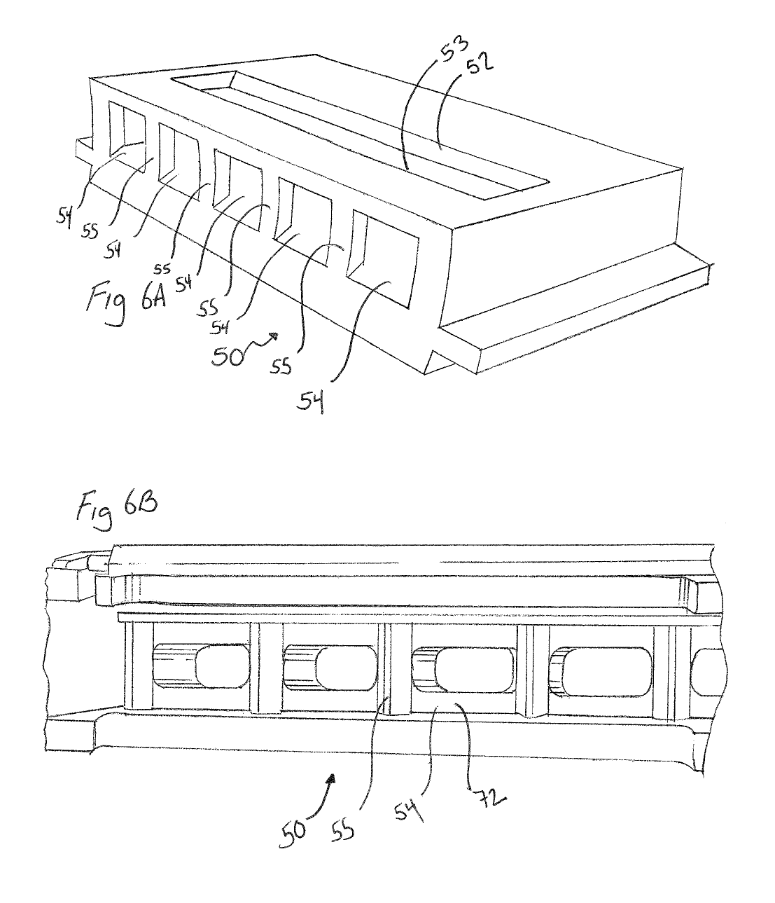

In reference to FIGS. 6A and 6B, a bed 50 in accordance with one embodiment of the present invention is illustrated. The bed 50 is machined from a metal, however it should be understood that the present invention is not limited in this regard and that the bed may be made from any material known in the art. The bed 50 defines the ram chamber 53. The ram chamber 53 is configured so that the ram 60 (not shown in FIGS. 6A and 6B) can be slidably disposed therein. The ram chamber 53 has an inlet 52 which is adjacent to the positive pressure rollers 40. The ram chamber 53 further has an outlet 54. The outlet 54 includes a plurality of dividers 55 extending therethrough. The dividers 55 are configured to separate the dough as it is forced through the outlet 54 by the stroke of the ram 60. An internal surface of the dividers 55 forms an angle to further facilitate the separation of the dough.

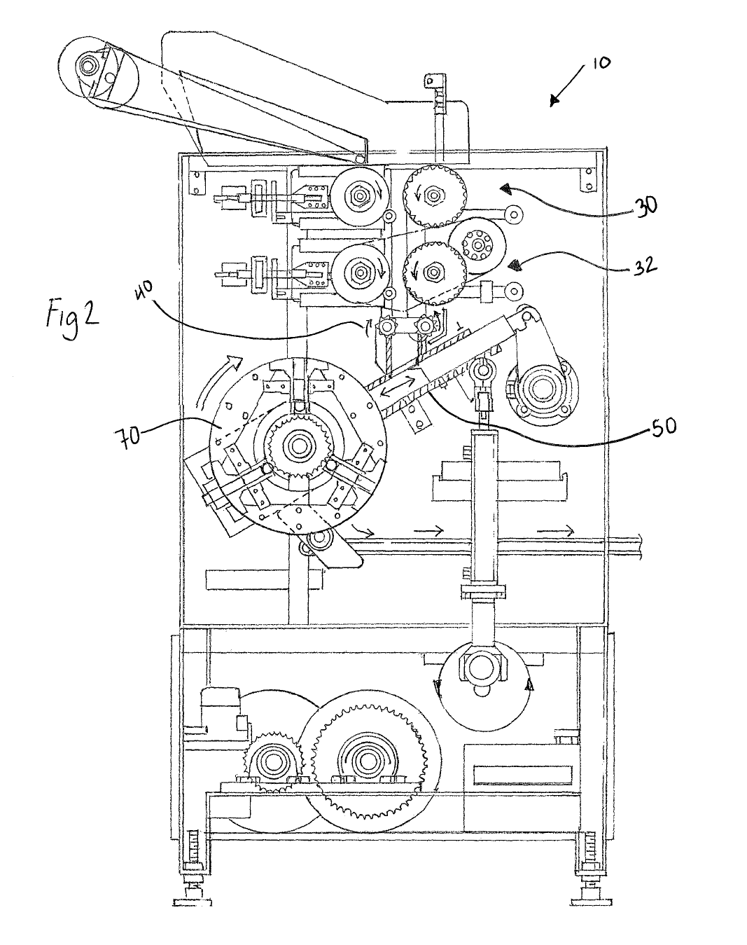

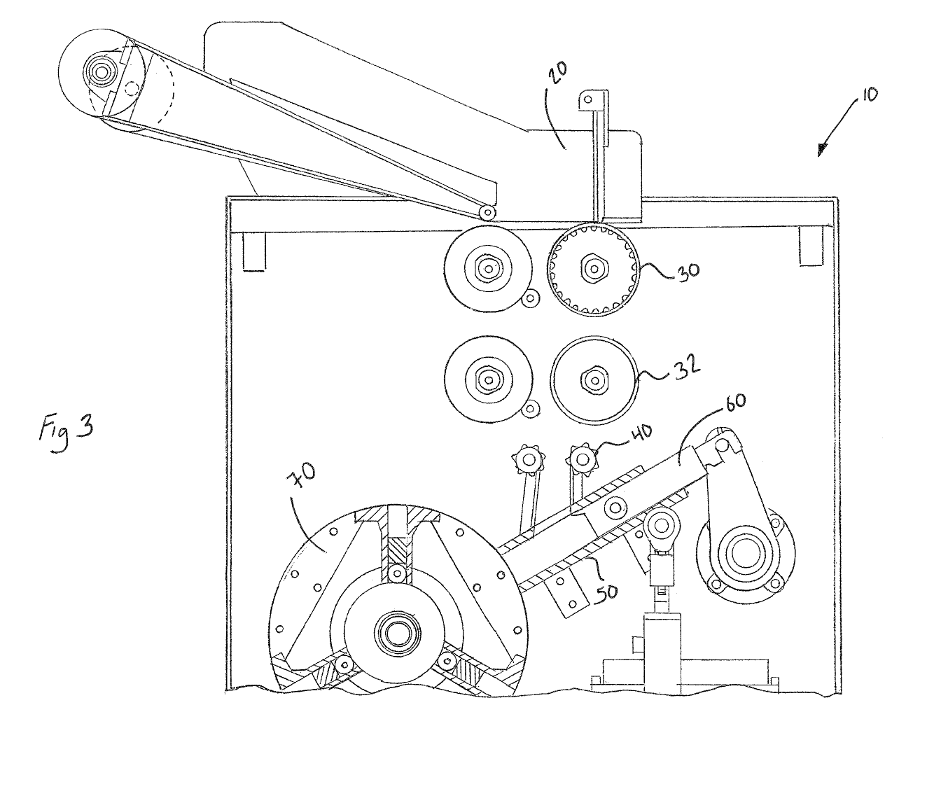

In a preferred embodiment shown in FIGS. 2 and 3, and 10A-10L, the bed 50 is angled approximately thirty degrees above horizontal to feed dough into the scaling chambers 73 of the head 70. The direction of rotation of the head 70 is further illustrated via an arrow.

In reference to FIGS. 7A and 7B, the positive pressure rollers 40 are attached to the bed 50 so that dough that passes through the positive pressure rollers is forced into the ram chamber 53. The pair of positive pressure rollers 40 comprises a first roller and a second roller. The first roller and the second roller are spaced apart and fixed relative to each other. The diameter of the positive pressure rollers 40 is smaller relative to that of the infeed rollers 30, 32. The positive pressure rollers 40 are operated by a positive pressure motor that is independent from the first motor and the second motor associated with the first pair of infeed rollers 30 and the second pair of infeed rollers 32. The positive pressure rollers 40 are adjacent to the second pair of infeed rollers 32. The positive pressure rollers 40 receive the ribbon of dough from the second pair of infeed rollers 32 and force it through the inlet 52 into the ram chamber 53 defined by the bed 50.

The pair of positive pressure rollers 40 rotate such that a speed of the outer surface of the rollers is approximately two to three times greater than the speed of the ribbon of the dough exiting from the second pair of infeed rollers 32. In this manner, the positive pressure rollers 40 ensure that the dough is forced into the ram chamber 53 and that an adequate amount of dough is maintained in the ram chamber 53 for continuous operation of the apparatus 10. As shown in FIG. 1, the positive pressure rollers 40 are in communication with the controller 80 and the rotational speeds of the rollers can be controlled therefrom, including through a feedback loop based at least in part on data received from a monitoring device, such as disclosed above with the first and second pair of infeed rollers 30, 32.

In reference to FIGS. 1 and 5A, the head 70 is generally circular in a cross section thereof and rotates about an axis of rotation 76. The head 70 has a plurality of scaling chambers 73 disposed in a surface thereof for receiving dough from the outlet 54 of the ram chamber 53. The scaling chambers 73 are aligned along a length of the head 70 parallel to the axis of rotation 76. In the embodiment shown, the adjustable scaling chambers 73 are formed in removable cassettes 72 that are received in the head 70 between fixed outer portions thereof 71. Each scaling chamber 73 has a scaling piston 74 slidably disposed therein. Below each piston 74 in each scaling chamber 73 is a scaling bar 75. The scaling bar 75 can be used to limit the travel of the scaling piston 74 in the scaling chamber 73. By using different sized scaling bars 75 it is possible to affect the desired size and/or weigh of the scaled pieces of dough. The travel of scaling piston 74 is determined by cam 91, which retracts the scaling piston 74 to a maximum extent to define the volume of a scaling chamber 73 when the scaling chamber 73 is adjacent to the outlet 54 of the ram chamber 53, and to extend the scaling piston 74 to eject contents of the scaling chamber 73 when the scaling chamber 73 is adjacent to a conveyer.

In reference to FIGS. 9A-9C, a process for removing a cassette is illustrated. In the embodiment shown, the cassettes are made from polyoxymethylene, a thermoplastic material sold under the brand name Delrin®. It should be understood, however, that the present invention is not limited in this regard. The cassettes 74 can be easily removed by an operator to facilitate changing of the scaling weights and to facilitate cleaning of the apparatus 10. In reference to FIG. 9A, the operator stops that head 70 so that a cassette 74 is visible and accessible through an opening in the apparatus 10. As shown in FIG. 5B, the operator inserts two keys 92, one each side of the cassette 74, into key holes configured to receive the keys. The operator then rotates the keys 92, thereby unlocking the cassette 74 from the head 70. The operator subsequently pulls back on the keys to remove the cassette 74 from the head 70. The keys 92 are configured such that the operator can use them to lift the cassette from the head 70. In this manner, with the present invention it is possible to remove the cassette 74 from the head 70.

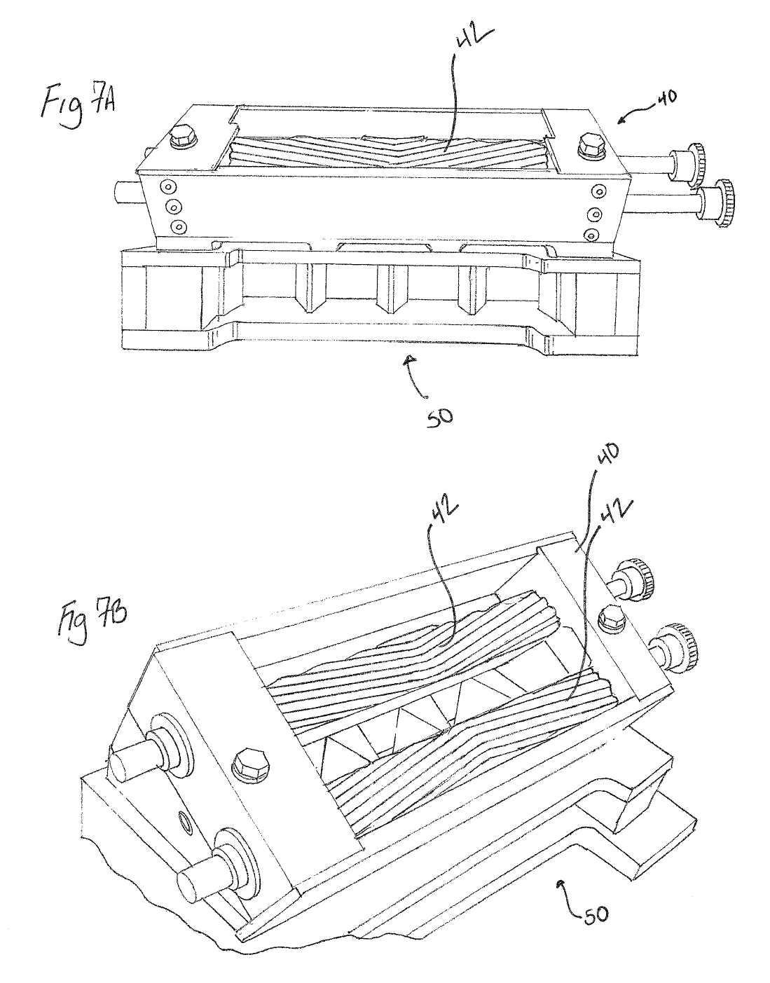

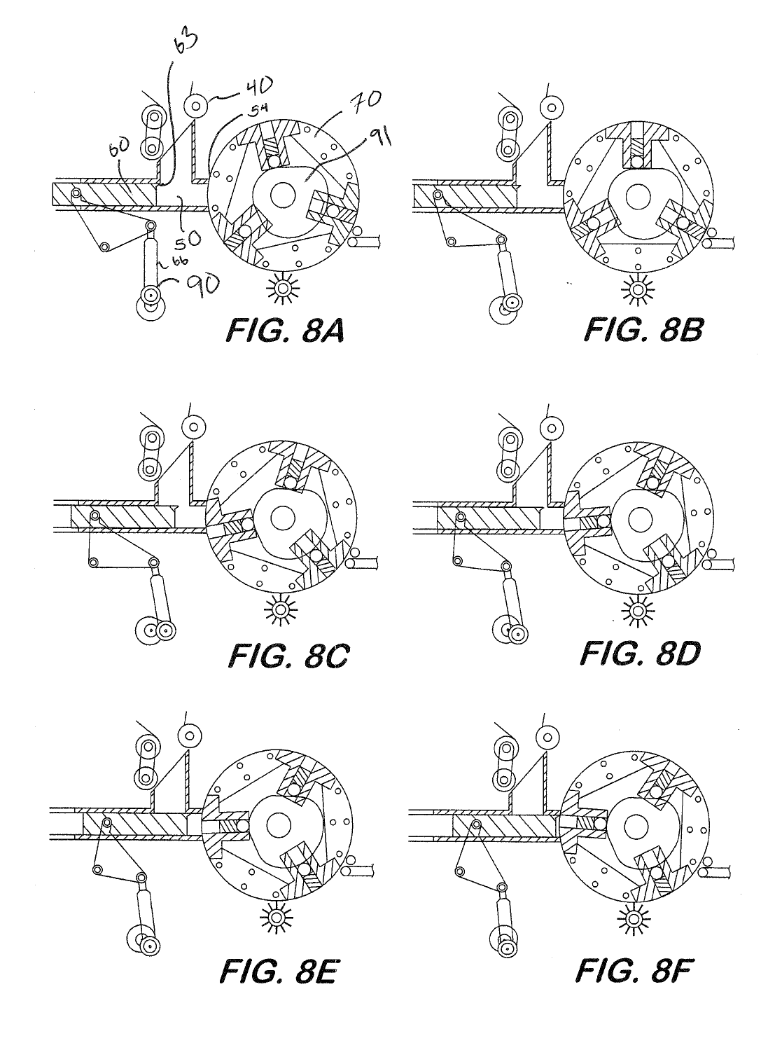

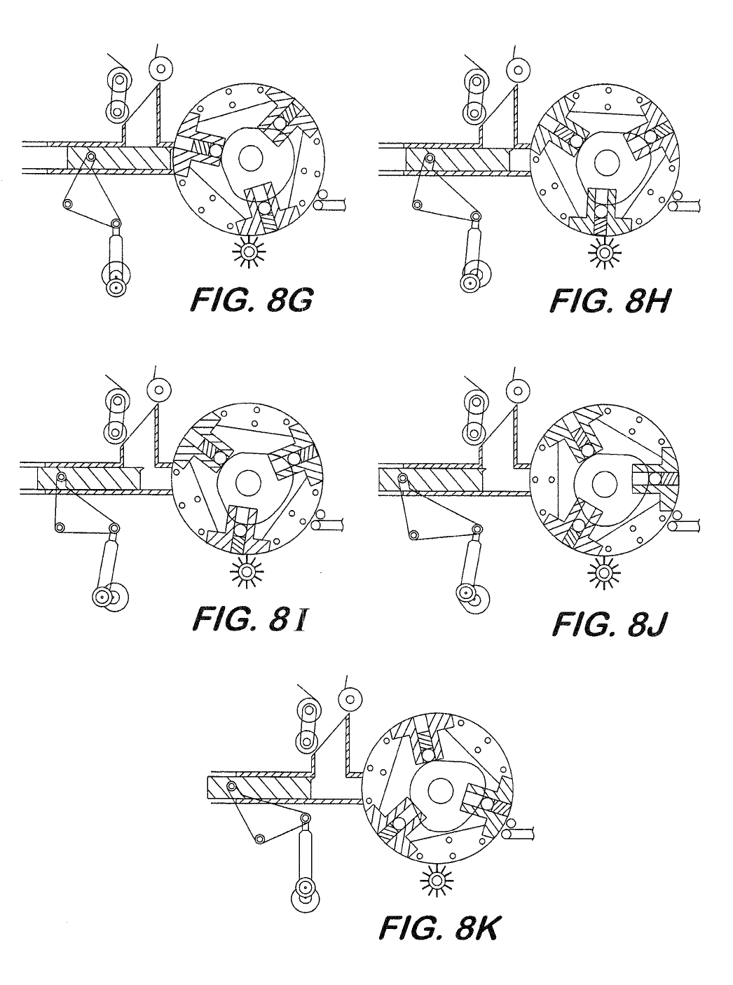

In reference to FIGS. 8A-8K, one configuration of a bed and head are illustrated. In this embodiment, the dough is compressed in the scaling chamber and the head rotates approximately 230 degrees clockwise before it is ejected. It should be understood, however, that the present invention is not limited in this regard and that a person of ordinary skill in the art will understand that the head can be configured to rotate in either direction, depending on the configuration of the apparatus and the production line, FIGS. 8A-8K illustrate operation of the apparatus as the crank shaft 90 (identified in FIG. 8A) for driving the ram rotates 360 degrees, causing a complete down stroke and upstroke of the ram within the ram chamber. It should be understood that during this process, the pair of positive pressure rollers 40 are configured to maintain an ample supply of dough in the ram chamber 53 during operation.

In FIG. 8A, the ram 60 is in a fully retracted position, and a portion of the head 70 not having any scaling chambers 73 in its circumferential surface is adjacent to the outlet 54. In reference to FIG. 8B, the crank shaft for the ram 60 has rotated 45 degrees beginning the down stroke of the ram 60. The head 70 has rotated 15 degrees, thereby moving the first row of scaling chambers 73 closer to the outlet 54. It should be understood that in this configuration the movement of the crank shaft and the movement of the head 70 is linked so that the crank shaft reciprocates three times for each rotation of the head 70. The three reciprocations of the ram crank shaft provide the three down strokes of the ram to provide the necessary force to push dough into the three rows of scaling chambers 73 in the head 70. FIGS. 8A-8K illustrate this action.

In reference to FIG. 8E, the crank shaft has rotated 135 degrees. The head 70 has also rotated so that a scaling chamber 73 is adjacent to the outlet 54 of the ram chamber 53. The scaling chamber 73 is opened during its rotation due to the changing shape of cam disposed in the head 70. As the scaling chamber 73 is opened to a maximum extent, the down stroke of the ram 60 extrude a volume of dough into the scaling chamber 73 (illustrated in 8F). The upper surface of the leading edge of the ram includes a pointed edge 63. The pointed edge cuts across the volume of dough received in the ram chamber 53. During operation, the down stroke of the ram does not extend entirely to the outlet 54 of the ram chamber 53. Still, in certain situations, the down force caused by the ram 60 is too great such that it if the ram completed a full down stroke, it could damage the apparatus 10. Over pressure is limited by a hydraulic cylinder 66 that is connected to the linkage assembly for driving the ram (identified in FIG. 5B). The hydraulic cylinder serves as a pressure relieve valve.

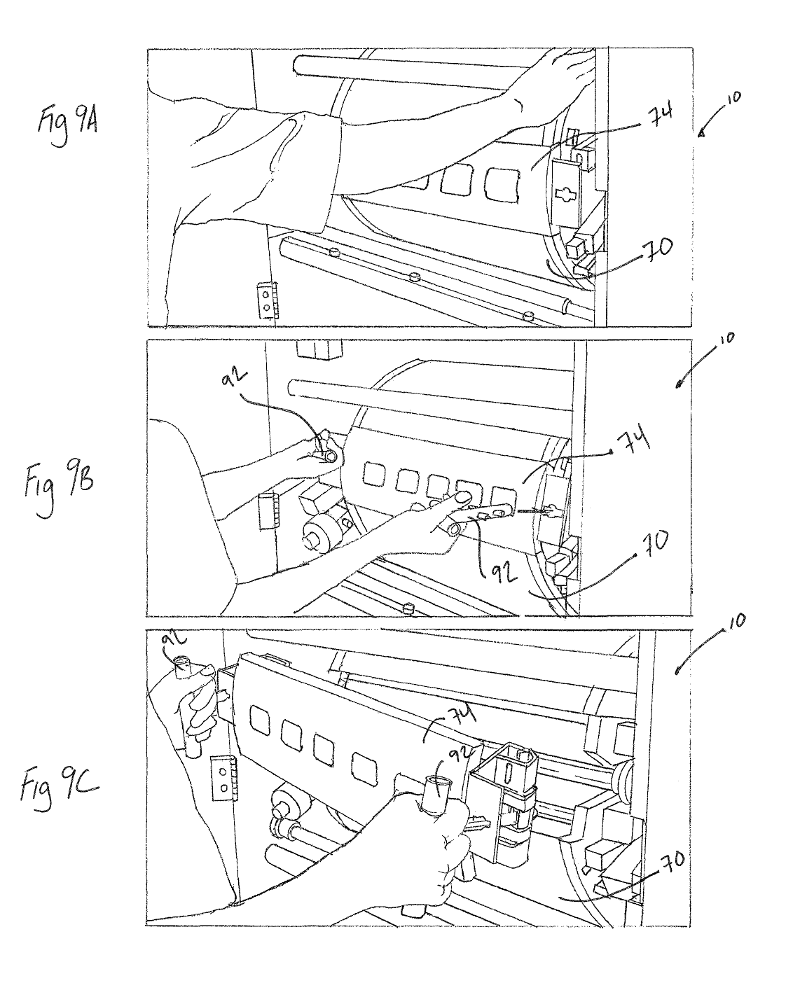

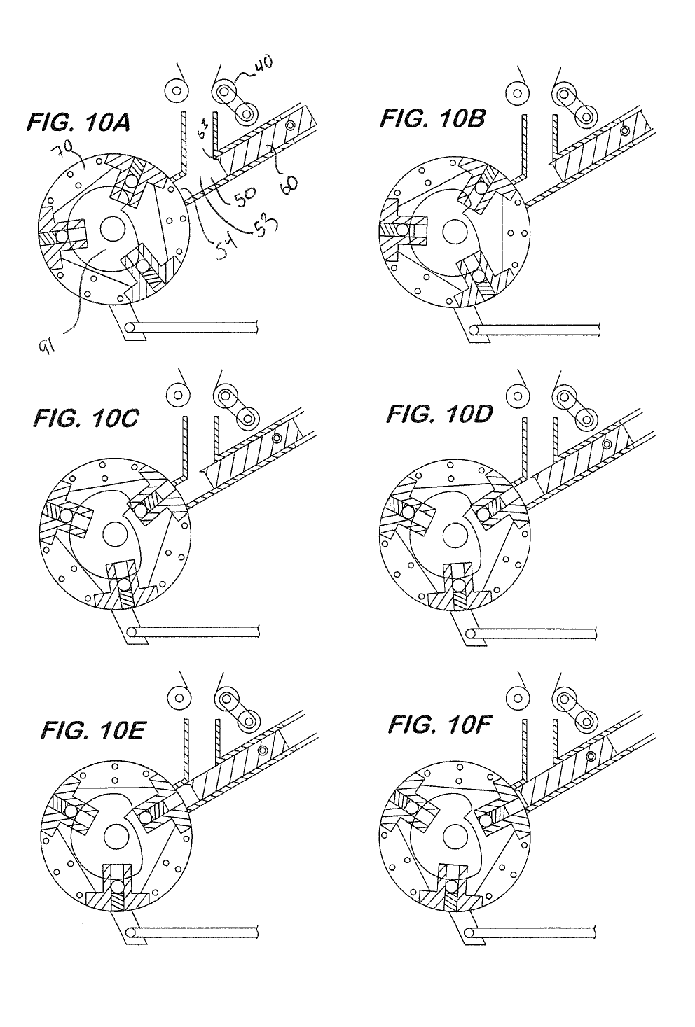

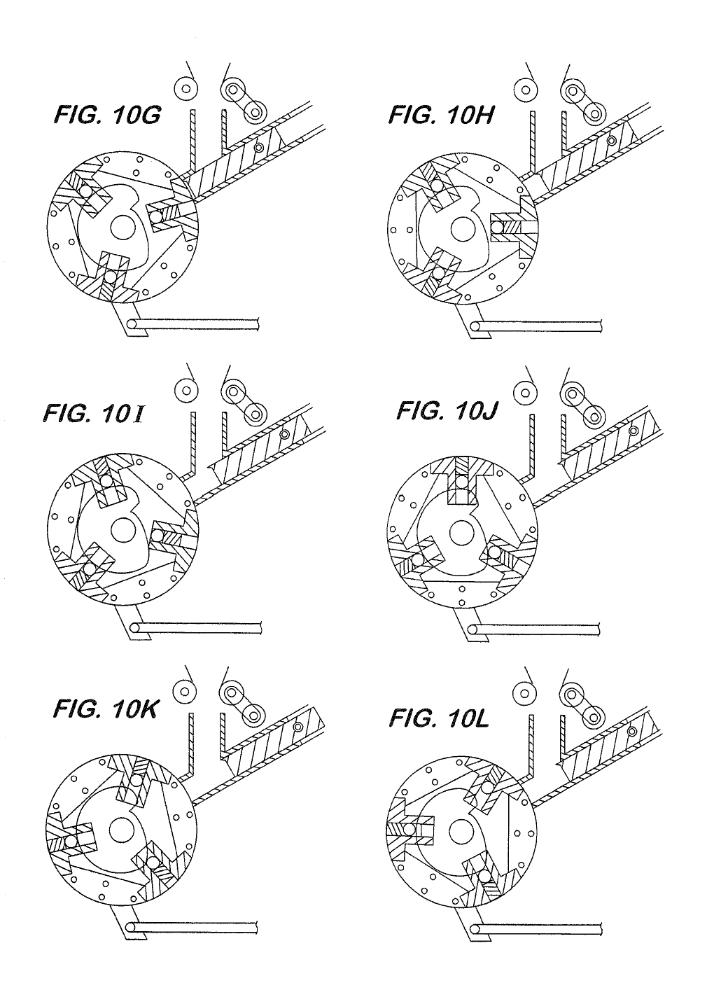

In reference to FIGS. 10A-10L, a preferred embodiment in which the bed 50 is angled approximately thirty degrees above horizontal to feed dough into the scaling chambers 73 of the head 70 is shown. In this embodiment, the dough is compressed in the scaling chamber and the head rotates approximately 90 degrees clockwise before it is ejected at the ejection location of FIG. 10L. It should be understood, however, that the present invention is not limited in this regard and that a person of ordinary skill in the art will understand that the head can be configured to rotate in either direction, depending on the configuration of the apparatus and the production line. FIGS. 10A-10K illustrate operation of the apparatus as the crank shaft (not shown in the FIGS) for driving the ram rotates 360 degrees, causing a complete down stroke and upstroke of the ram within the ram chamber. FIG. 10L illustrates the beginning of the next down stroke. It should be understood that during this process, the pair of positive pressure rollers 40 are configured to maintain an ample supply of dough in the ram chamber 53 during operation. It should be further understood that only a portion of the apparatus is shown in FIGS. 10A-10L

In FIG. 10A, the ram 60 is in a fully retracted position, and a portion of the head 70 not having any scaling chambers 73 in its circumferential surface is adjacent to the outlet 54. In reference to FIG. 10B, the crank shaft for the ram (not shown in FIGS. 10A-10L) has rotated 45 degrees beginning the down stroke of the ram 60. The head 70 has rotated 15 degree in the clock wise direction, thereby moving the first row of scaling chambers 73 closer to the outlet 54. It should be understood that in this configuration the movement of the crank shaft and the movement of the head 70 is linked so that the crank shaft reciprocates three times for each rotation of the head 70. The three reciprocations of the ram crank shaft provide the three down strokes of the ram to provide the necessary force to push dough into the three rows of scaling chambers 73 in the head 70. FIGS. 10A-10L illustrate this action.

In reference to FIG. 10E, the crank shaft has rotated 135 degrees. The head 70 has also rotated so that a scaling chamber 73 is adjacent to the outlet 54 of the ram chamber 53. The scaling chamber 73 is opened during its rotation due to the changing shape of cam 91 disposed in the head 70. As the scaling chamber 73 is opened to a maximum extent, the down stroke of the ram 60 compress a volume of dough into the scaling chamber 73 (illustrated in 10F). The upper surface of the leading edge of the ram includes a pointed edge 63. The pointed edge cuts across the volume of dough received in the ram chamber 53. During operation, the down stroke of the ram does not extend entirely to the outlet 54 of the ram chamber 53. Still, in certain situations, the down force caused by the ram 60 is too great such that it if the ram completed a full down stroke, it could damage the apparatus 10. Over pressure is limited by a hydraulic cylinder that is connected to the linkage assembly for driving the ram (identified in FIG. 5B). The hydraulic cylinder serves as a pressure relieve valve.

In reference to FIGS. 10G through 10L, the head 70 rotates past outlet 54 of the ram chamber 53. A portion of bed that defines the outlet 54 shears the dough disposed in the scaling chamber 73 from the remaining portion of dough in the ram chamber 53, thereby forming the scaled portion of dough. As the head 70 rotates, an action of the cam 91 forces the scaling piston 74 to eject scaled dough from the scaling chamber 73. As is shown in FIG. 4, the apparatus 40 includes a plurality of surfaces 92 that receive the ejected scaled dough and convey it away for further processing.

The disclosed apparatus 10 has been able to consistently achieve a rate of one hundred ram down strokes per minute to produce scaled dough having an error variation of less than 1% plus or minus the target weight. In the disclosed embodiment there are five scaling chambers in each cassette. As a result, the apparatus in accordance with one embodiment of the present invention can scale approximately five hundred pieces of scaled dough per minute.

Although the invention has been described with reference to a particular arrangement of parts, features and the like, these are not intended to exhaust all possible arrangements or features, and indeed many other modifications and variations will be ascertainable to those of skill in the art.

What is claimed is:

1. Apparatus for scaling dough, comprising:
a pair of infeed rollers configured to receive a block of dough and form a ribbon therefrom;
a pair of positive pressure rollers adjacent to the infeed rollers and configured to receive the ribbon of dough from the infeed rollers, the positive pressure rollers being configured to rotate so that a speed of an outer surface the pair of positive pressure rollers is greater than a speed of the ribbon of dough being received by the positive pressure rollers from the infeed rollers;
a bed defining a ram chamber having an inlet and an outlet, the bed being adjacent to the pair of positive pressure rollers so that dough from the positive pressure rollers is received in the ram chamber through the inlet and the pair of positive pressure rollers maintain a sufficient supply of dough in the ram chamber to enable continuous operation of the apparatus;
a ram disposed in the ram chamber and being configured to reciprocate therein so as to compress at least a portion of the dough received therein;
a rotatable head having at least one scaling chamber, the rotatable head being adjacent the outlet of the ram chamber;
wherein the rotation of the head and the reciprocation of the ram are synchronized such that a stroke of the ram extrudes dough received in the ram chamber and forces a portion thereof through the outlet of the ram chamber and into the scaling chamber;
wherein the rotation of the head relative to the bed shears the dough received in the scaling chamber from the dough disposed in the ram chamber, thereby forming a scaled portion of dough.

2. The apparatus of claim 1, the head further comprising;
a removable cassette, the cassette extending along a length of an outer surface of the head parallel to an axis of rotation of the head, the scaling chamber being formed in the cassette.

3. The apparatus of claim 2, the cassette further comprising a plurality of scaling chambers formed therein.

4. The apparatus of claim 3, the head comprising three cassettes, each of the cassettes extending along a length of the head parallel to the axis of rotation of the head, and each of the cassettes positioned at 120 degree intervals in the circumference of the head about the axis of rotation.

5. The apparatus of claim 3 wherein the cassette is received in the head and fixed relative thereto via two mechanical locks being operable by a key associated therewith.

6. The apparatus of claim 1, wherein the ram cycles at eighty or more strokes per minute.

7. The apparatus of claim 6, wherein the ram cycles at one hundred or more down strokes per minute.

8. The apparatus of claim 1, wherein the speed of the outer surface of the pair of positive pressure rollers is between two and three times greater than the speed of the ribbon of dough being received by the positive pressure rollers from the pair of infeed rollers.

9. The apparatus of claim 8, further comprising:
a controller, the controller in communication with a drive system associated with each pair of rollers
one or more devices for monitoring the rate of dough exiting a pair of rollers;
software executing on the controller for adjusting the rate of rotation of one or more of the pairs of rollers based on information received from the one or more monitoring devices.

10. The apparatus of claim 1, wherein the volume of the scaling chamber is adjustable.

11. The apparatus of claim 10, wherein a size of a scaling bar determines the volume of the scaling chamber.

12. The apparatus of claim 1, further comprising scaling pistons disposed in the scaling chambers, the scaling pistons reciprocating to retract the scaling pistons to a maximum extent to define the volume of the scaling chambers when the scaling chambers are adjacent to the outlet of the ram chamber, and to extend the scaling pistons to eject contents of the scaling chambers.

13. The apparatus of claim 11, further comprising a cam, the position of the scaling piston in the scaling chamber being determined by the cam.

14. Apparatus for scaling dough, comprising:
a pair of infeed rollers configured to receive a block of dough and form a ribbon therefrom;
a pair of positive pressure rollers adjacent to the infeed rollers and configured to receive the ribbon of dough from the infeed rollers;
a bed defining a ram chamber having an inlet and an outlet, the bed being adjacent to the pair of positive pressure rollers so that dough from the positive pressure rollers is received in the ram chamber through the inlet and the pair of positive pressure rollers maintain a sufficient supply of dough in the ram chamber to enable continuous operation of the apparatus;
a ram disposed in the ram chamber and being configured to reciprocate therein so as to extrude dough received therein;
a rotatable head closely fitted against the outlet of the ram chamber;
at least one removable cassette located in the rotatable head, the removable cassette having a plurality of volumetric dough scaling chambers provided therein;
scaling pistons disposed in the scaling chambers, the scaling pistons reciprocating to retract the scaling pistons to a maximum extent to define the dough scaling volume of the scaling chamber when the scaling chamber is adjacent to the outlet of the ram chamber whereby the ram can extrude dough into the scaling chamber, and to extend the scaling piston to eject contents of the scaling chamber.

15. The apparatus of claim 14, the head comprising three removable cassettes, each of the cassettes extending along a length of the head parallel to the axis of rotation of the head, and each of the cassettes positioned at 120 degree intervals in the circumference of the head about the axis of rotation.

16. The apparatus of claim 14, wherein the volume of the scaling chamber is adjustable.

17. The apparatus of claim 16, wherein a size of a scaling bar determines the volume of the scaling chamber.

18. The apparatus of claim 14, further comprising a cam, the position of the scaling piston in the scaling chamber being determined by the cam.

19. A method of scaling dough, comprising:
feeding dough to a pair of infeed rollers to form a ribbon of dough;
feeding the ribbon of dough to a pair of positive pressure rollers to increase pressure in the ribbon of dough and deliver pressurized dough to a ram chamber;
extruding dough from the ram chamber using a reciprocating ram to load dough into volumetric dough scaling chambers provided in removable cassettes in a rotatable head, the dough scaling chambers having a defined dough scaling volume determined by a maximum retraction of scaling pistons in the dough scaling chambers;
shearing the dough by rotation of the head relative to the ram chamber, thereby forming a scaled portion of dough;
ejecting the scaled portion of dough by extending the scaling piston.

20. The method of claim 19, wherein the ejecting step occurs after 90 degrees of rotation from the extruding step.
